(19) United States
(12) Patent Application Publication
(10) Pub. No.: US 2026/0235539 A1
(43) Pub. Date: Aug. 13, 2026

(54) SYSTEMS AND METHODS FOR PETAHERTZ OPTOELECTRONICS

(71) Applicant: University of Pittsburgh - Of the Commonwealth System of Higher Education, Pittsburgh, PA (US)

(72) Inventors: Hrvoje Petek, Pittsburgh, PA (US); Shijing Tan, Pittsburgh, PA (US); Zehua Wang, Pittsburgh, PA (US); Marcel Reutzel, Bovenden (DE)

(73) Assignee: Georg-August-Universität Göttingen Stiftung Öffentlichen Rechts, Göttingen (DE)

(21) Appl. No.: 19/156,488

(22) PCT Filed: Feb. 15, 2024
(86) PCT No.: PCT/US2024/015997

§ 371 Date: Aug. 14, 2025

Related U.S. Application Data
(60) Provisional application No. 63/485,075, filed on Feb. 15, 2023.

(51) Int. Cl. G01N 23/227

(52) U.S. Cl. CPC G01N 23/227

(57) ABSTRACT

Methods and systems for emitting photoelectrons from a solid surface are disclosed. According to one embodiment, the system includes a light source configured to generate a light beam comprising a first pulse and a second pulse separated by a time delay. The system includes a material defining a surface configured to be exposed to the light beam. The material has a dielectric permittivity of approximately 0 when exposed to the light beam. The light beam causes: formation of electromagnetic field waves at a material-dielectric interface associated with the surface, and emission of photoelectrons from the material at the material-dielectric interface, wherein the emission is a function of the time delay and an intensity of the light beam.

### CROSS-REFERENCE TO RELATED APPLICATIONS

This application claims priority to and the benefit of U.S. Provisional Patent Application No. 63/485,075, entitled “PETAHERTZ OPTOELECTRONICS,” filed on Feb. 15, 2023, the entire contents of which are incorporated herein by reference.

### TECHNICAL FIELD

The following disclosure is directed to methods and systems for causing emission of electrons and, more specifically, methods and systems for causing and controlling emission of electrons using petahertz (PHz) frequencies.

### BACKGROUND

Optical fields can excite quantum transitions (e.g., quantum phase transitions and electronic state transitions) and/or drive charge currents in solid state materials. Quantum transitions can change the rotational, vibrational, and/or electronic quantum numbers in any of atoms, molecules, and/or solids. The rotational transitions and vibrational transitions can occur in the terahertz (THz) frequency region (10¹² Hz) and electronic transitions can occur in the petahertz (PHz) frequency region (10¹⁵ Hz).

Classical electronic currents are usually driven by electric fields. Everyday electronic devices are based on applying electric field pulses to accelerate Bloch electrons that occupy electronic bands by qE force, where E is the electric field and q is the electron charge. In electronic devices, applied electric fields can transmit signals at hertz (Hz) to gigahertz (GHz) frequencies. For example, current fifth generation (5G) network capable mobile phones can receive and transmit signals at an approximately 3 GHz operating frequency, which is expected to increase by a factor of 10 as the 5G technology evolves over time. Optical electric and magnetic fields can drive Bloch electrons much faster in the THz range (e.g., as explored in light wave electronics). In the field of THz spectroscopy, intense THz electromagnetic fields can drive electron currents and cause non-linear interactions in solid-state materials (e.g., insulating and semiconducting solids). In some cases, intense THz electromagnetic fields can also drive inter-electronic band electron transitions and generate harmonics of driving frequencies of the THz electromagnetic fields.

In the 400-800 THz range of the visible spectrum, optical fields can excite quantum transitions, thereby changing the type of light-matter interactions from a classical type to a quantum type. The voltage potential exerted by an optical field in the quantum type can be defined as \vec{V}=−\hat{D}·\vec{E}, where \hat{D} is the optical transition moment, or a possibly higher electric or magnetic moment, and the photoinduced current is proportional to intensity of light (e.g., 1∝\vec{E}²). However, techniques for controlling the classical electron response in the quantum regime via design of the interacting optical field and choice of a material that responds to the optical field are desired to drive and control optoelectronic currents. Further, electromagnetic fields that can drive optoelectronic currents at frequencies higher than existing THz range techniques are desired to enable operation of electronic devices at increased frequencies.

### SUMMARY

Methods and systems for emitting electrons using PHz frequencies are disclosed. The emitted electrons may be photoelectrons emitted from a material at material-dielectric interfaces (e.g., a metal-vacuum interface) in response to a light beam that irradiates the material. In one aspect, the disclosure features a system for emitting photoelectrons. The system can include a light source configured to generate a light beam including a first pulse and a second pulse separated by a time delay. The system also includes a material defining a surface configured to be exposed to the light beam, the material having a dielectric permittivity of approximately 0 when exposed to the light beam. The light beam causes formation of electromagnetic field waves at a material-dielectric interface associated with the surface, and emission of photoelectrons from the material at the material-dielectric interface, where the emission is a function of the time delay and an intensity of the light beam.

Various embodiments of the system can include one or more of the following features. The light beam can include an oscillation frequency from about 0.8 petahertz (PHz) to about 1.2 PHz. The light beam can include a wavelength of about 320 nanometers. A wavelength of the light beam can be selected based on a work function of the material and a frequency dependent dielectric permittivity response. The system may further include an interferometer configured to receive light from the light source and generate the first pulse and the second pulse using a beam splitter. The time delay can define a phase shift between a waveform in the first pulse and a waveform in the second pulse. The time delay can be from about 1 attosecond to about 600 attoseconds. The light beam can be directed to the surface at an angle from about 50° to about 70° relative to a normal direction of the surface. The light beam can be configured to modulate a work function of the material to cause emission of the photoelectrons. The light beam can be configured to cause transfer of the photoelectrons of the material from a Fermi energy level into a vacuum energy level. The dielectric permittivity of the material can be a function of an oscillation frequency of the light beam. The material can include a metallic single crystal material or a semiconductor material. The material can include an epsilon near zero (ENZ) material.

The emission of the photoelectrons can be by multi-photon photoemission and/or field emission. The material-dielectric interface can include a material-vacuum interface or a material-semiconducting material interface. The system can be configured of use in a nanophotonic system. A response of the photoelectrons can be configured to carry and/or process information for quantum computing. A response of the photoelectrons can be configured for a signal processing application. The surface can form part of an electrical circuit. The system can be included in at least one of a spectroscopy device, a microscopy device, or an electron diffraction device.

In another aspect, the disclosure features a method for emitting photoelectrons. The method includes generating a light beam including a first pulse and a second pulse separated by a time delay. The method also includes exposing a material defining a surface to the light beam, where (i) the material has a dielectric permittivity of approximately 0 when exposed to the light beam, and (ii) the light beam causes (a) formation of electromagnetic field waves at a material-dielectric interface associated with the surface, and (b) emission of photoelectrons from the material at the material-dielectric interface, where the emission is a function of the time delay and an intensity of the light beam.

Various embodiments of the method can include one or more of the following features. The light beam can include an oscillation frequency from about 0.8 petahertz (PHz) to about 1.2 PHz. The light beam can include a wavelength of about 320 nanometers. A wavelength of the light beam can be selected based on a work function of the material and a frequency dependent dielectric permittivity response. The method may further receiving, by an interferometer, light from the light source and generating, by the interferometer, the first pulse and the second pulse using a beam splitter. The time delay can define a phase shift between a waveform in the first pulse and a waveform in the second pulse. The time delay can be from about 1 attosecond to about 600 attoseconds. The light beam can be directed to the surface at an angle from about 50° to about 70° relative to a normal direction of the surface. The light beam can be configured to modulate a work function of the material to cause emission of the photoelectrons. The light beam can be configured to cause transfer of the photoelectrons of the material from a Fermi energy level into a vacuum energy level. The dielectric permittivity of the material can be a function of an oscillation frequency of the light beam. The material can include a metallic single crystal material or a semiconductor material. The material can include an epsilon near zero (ENZ) material.

The emission of the photoelectrons can be by multi-photon photoemission and/or field emission. The material-dielectric interface can include a material-vacuum interface or a material-semiconducting material interface. The method can be configured of use in a nanophotonic system. A response of the photoelectrons can be configured to carry and/or process information for quantum computing. A response of the photoelectrons can be configured for a signal processing application. The surface can form part of an electrical circuit. The method can be included in at least one of a spectroscopy method, a microscopy method, or an electron diffraction method.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure. In the following description, various embodiments of the present disclosure are described with reference to the following drawings.

FIG. 1 is a schematic diagram of an example system for causing and controlling emission of electrons using PHz frequencies, according to some embodiments.

FIG. 2 is a flowchart of an example method for causing and controlling emission of electrons using PHz frequencies, according to some embodiments.

FIG. 3 is a schematic diagram of competing perturbative two photon photoemission (2PP) and nonperturbative field emission from a surface in response to a light beam, according to some embodiments.

FIG. 4A is a diagram of a photoelectron response of a surface in response to a light beam, according to some embodiments.

FIG. 4B is a vertical line profile of a photoelectron response of a surface in response to a light beam, according to some embodiments.

FIG. 4C is a horizontal line profile of a photoelectron response of a surface in response to a light beam, according to some embodiments.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

In various examples, “material-dielectric interface” can refer to an interface formed between a material and an adjacent dielectric. The material can be or include, for example, a metal (e.g., silver), a semiconducting material (e.g., SnSe₂), or an epsilon near zero (ENZ) material. The dielectric can be or include, for example, a vacuum, a gas (e.g., air, nitrogen, or helium), an electrically insulating material such as glass, or a semiconducting material.

In various examples, an “epsilon near zero (ENZ) material” can refer to material having a dielectric function permittivity (referred to herein as “ϵ” or “epsilon”) that is near zero or equal to zero. In certain examples, for ϵ that is near 0, ϵ, a real component of ϵ, or an absolute value thereof, may be less than 0.01, 0.1, 0.2, 0.5, 1, 2, 5, or 10. The value of ϵ for ENZ materials (and/or other materials) can vary based on material properties and/or according to an oscillation frequency of light irradiated on the material.

In various examples, an “ENZ frequency” (also referred to as “ENZ oscillation frequency,” “bulk plasma frequency,” or “ωₚ”) refers to an oscillation frequency of an optical field that causes a material (e.g., an ENZ material) to have ϵ near zero or equal to 0 when the material is exposed to the optical field. The ENZ frequency may depend on a type of material.

In various examples, “time delay” can refer to a separation in time between two identical waveforms (e.g., electromagnetic waves) that are phase-shifted and traveling through space. The time delay can be, for example, an amount of time it will take one wave to reach a current location of the other wave. In certain examples, time delay can be a duration of time between a reference point within a waveform of a first light pulse to a second reference point within a waveform of a second light pulse. The first and second light pulses may have the same frequency and/or amplitude. The first reference point and the second reference point may correspond to a same position (e.g., a maximum, a minimum, or a zero) within the oscillation cycles corresponding to the first and second light pulses. The time delay may be defined by a relative phase between the waveforms of the first light pulse and the second light pulse. For example, a time delay between the first light pulse and the second light pulse may be equivalent to a phase difference (φ) (e.g., radians) between the first light pulse and the second light pulse divided by an oscillation frequency (ω) (e.g., defined in radians/second) of the first light pulse and the second light pulse (e.g., φ/ω). In some cases, the time delay can be controlled with attosecond precision (e.g., well below one optical cycle) using the systems and methods described herein.

In various examples, “phase” (alternatively referred to as “phase shift” or “relative phase”) can refer to a relative position between two waveforms at a point in time (e.g., instant) on a waveform cycle. The phase can be measured in degrees (°) or radians, where 360° and 2π radians are each equivalent to one wavelength and correspond to one oscillation or cycle of a wave in a beam of light or optical field. In some cases, phase can refer to a position (e.g., a relative position) of one or more waveforms in a light beam.

In various examples, “intensity” can refer to a rate of energy flow per unit area. The intensity of a wave can be proportional to the square of the wave's amplitude (e.g., an electric field amplitude). In some cases, intensity can refer to an intensity or brightness of visible light or other electromagnetic radiation (e.g., a beam of light or a laser beam).

In various examples, “oscillation frequency” can refer to a frequency of oscillation of a wave and/or the number of electric field oscillations per unit time. In some cases, oscillation frequency can refer to a frequency of a waveform in visible light or other electromagnetic radiation.

In various examples, “light beam angle” can refer to an angle of incidence of a light beam relative to a surface irradiated by the light beam. For example, the light beam angle can be the angle between a ray of the light beam incident on the surface and a line perpendicular or orthogonal (e.g., a 90° angle) to the surface.

Improvements in systems and methods are described herein which can enable causing and controlling emission of photoelectrons (e.g., photoemitted electrons) using much higher, PHz frequencies than conventional solutions. For PHz frequencies, the primary (e.g., dominant) response of electrons to an applied optical field may be of a quantum mechanical nature. The quantum mechanical response of electrons in solid-state materials in response to PHz frequencies may enable quantum computing applications. In some cases, irradiation of a material using PHz frequencies can (i) modify electronic bands that govern electron motion in the material and (ii) drive electron currents as collective plasma excitations. In some cases, an optical field of light can penetrate a solid material as intense collective plasma excitations in a frequency region of the applied optical field where ϵ of the solid material changes between negative and positive (e.g., passes through ϵ=0). The optical field can be intensified by the surface electronic response at the material-dielectric (e.g., metal-vacuum) interface, reaching the peak theoretically at the multipole plasmon frequency. In an example, the multipole plasmon frequency may be about 0.7 times (about 70% of) the ENZ frequency, or may range from about 60% to about 80% of the ENZ frequency. The field intensification maximum, however, can be material dependent. ϵ of dielectric materials may be mostly positive (e.g., when the materials are exposed to frequencies near the frequencies corresponding to quantum transitions). ϵ of metals at low frequencies (e.g., less than 1 THz frequencies) are dominantly negative. ϵ of metals can increase based on an increasing frequency of an optical field of light applied to the metals. ϵ of metals can change between negative and positive (e.g., pass through ϵ=0) at a plasma frequency; thereafter, the e of metals can become increasingly positive.

In some cases, materials in which e can change between negative and positive (e.g., pass through ϵ=0) may be ENZ materials as described herein. Some examples of ENZ materials in which e transitions (e.g., transitions where ϵ changes from negative to positive or positive to negative) may occur in response to approximately visible light spectrum wavelengths (e.g., wavelengths ranging from the infrared to vacuum ultraviolet light) can include metal-ion doped metal oxides, hyperbolic materials, noble metals, and simple s-electron metals. As an example, wavelengths of optical fields of light that may cause ϵ of a material to change between negative and positive (e.g., pass through ϵ=0) can include wavelengths in a range of 30 nanometers (nm) to 300 micrometers (μm). Hyperbolic materials can be or include, for example, materials where one or two components (e.g., real or imaginary components) of ϵ passes through ϵ=0 (e.g., separately or together). Optical field wavelengths that may cause ϵ of a material to pass through ϵ=0 may be above or below a work function for removing an electron from the material. At an ENZ condition where ϵ of a material passes through zero, applied optical fields of light (e.g., from a vacuum dielectric) can generate intense electromagnetic fields at material-dielectric interfaces corresponding to the free electron plasma oscillations in the materials. Further, at an ENZ condition where ϵ of a material passes through zero in response to an optical field of light, a group velocity of the light can go to zero, a phase velocity of the light can become infinite, and electric and magnetic fields formed in response to the applied light can become decoupled. For such an ENZ condition, the linear dielectric response vanishes, and nonlinear responses dominate. The aspect of zero group velocity may be particularly significant based on slow light enhancing nonlinear responses, such as optical field harmonic generation and/or electron field emission.

In some embodiments, a region of a material in which e passes through ϵ=0 in response to an applied optical field may be referred to as an “ENZ region.” In an ENZ region of an ENZ material, an optical field (e.g., produced by a light beam generated by a light source) can modify a work function of the ENZ material in proportion to a strength (e.g., amplitude) and/or intensity (e.g., square of the amplitude) of the applied optical field. Accordingly, the applied optical field can cause electrons to be emitted from the ENZ material into a dielectric at a material-dielectric interface (e.g., metal-vacuum interface, metal-gas interface (e.g., metal-air interface, metal-nitrogen interface, or metal-helium interface), metal-glass interface, metal-“glass-like” semiconducting material interface, etc.) at far reduced optical field strengths relative to lower oscillation frequencies where ϵ of the material is negative. For example, in the case of a silver (e.g., Ag(111)) single crystalline material with (111) crystalline orientation, a light beam having an approximately 1 PHz (e.g., approximately 0.937 PHz) oscillation frequency can cause (i) the material to have ϵ=0 and (ii) emission from a surface of the material with a photon energy (ℏω) of approximately 3.8-3.9 electron volts (eV). the applied optical field can oscillate with a period of approximately 1 fs (e.g., approximately 1.068 fs) and can induce electron emission into the dielectric based on the strength (e.g., amplitude), intensity (e.g., square of the amplitude), and phase of the optical field. In some cases, a strength of the optical field may be proportional to the amplitude of a waveform of the optical field and an intensity of the optical field may be proportional to the squared amplitude of a waveform of the optical field. A number of electrons emitted by the surface (e.g., per unit of time) may be proportional to the amplitude of the waveform of the optical field. Accordingly, the techniques of the above-described example for a silver material can be used to control emission of electrons at PHz-level frequencies for a number of ENZ materials, including Ag(111).

The following description provides example methods and systems for emitting photoelectrons. Further, the description provides applications for the emitted photoelectrons.

### Systems and Methods for Control of Emission of Electrons

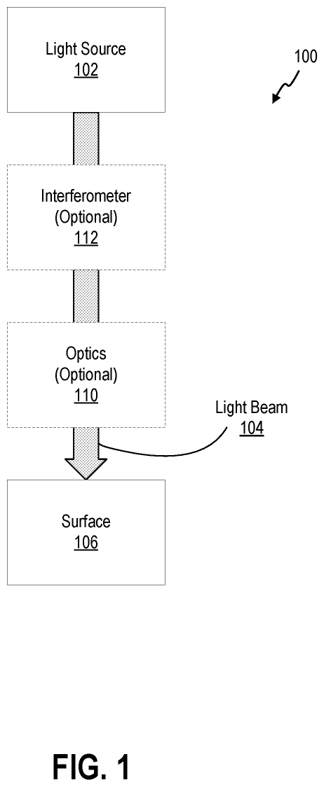

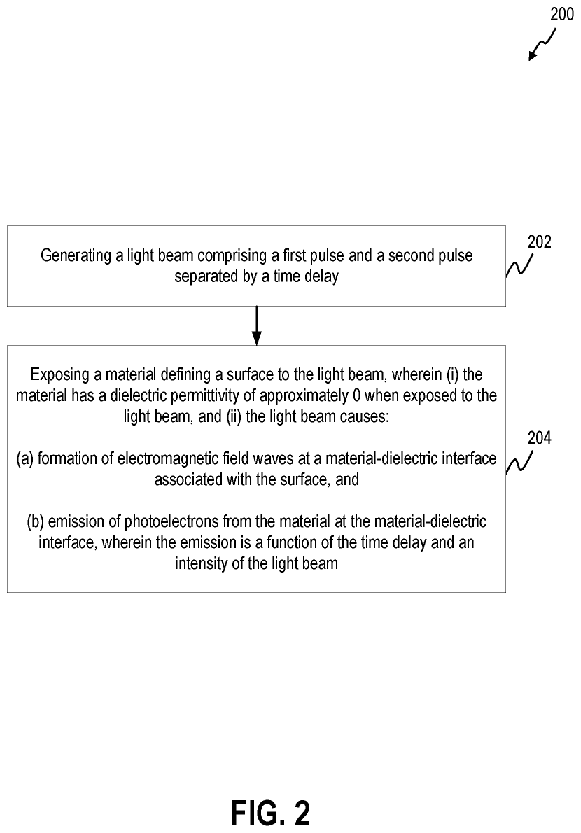

FIG. 1 illustrates an example system 100 for causing and controlling emission of electrons using PHz frequencies. FIG. 2 is a flowchart of a method 200 for causing and controlling emission of electrons using PHz frequencies by the example system 100.

Referring to FIG. 1, the example system 100 includes a light source 102 (e.g., laser) configured to generate a light beam 104 (e.g., laser beam). The light source 102 can be configured to generate a light beam 104 having a variable wavelength, a variable pulse duration, a variable oscillation frequency (e.g., color), and/or a variable polarization. In some cases, the light source 102 may be and/or include features of a noncollinear parametric amplification (NOPA) source described in the publication titled “Octave wide tunable UV-pumped NOPA: pulses down to 20 fs at 0.5 MHz repetition rate” to Homann et al., the entire contents of which are incorporated herein by reference. The light source 102 may include a NOPA source pumped by a laser system operating at 1 MHz. In certain examples, the laser system may be a Clark-MXR, Inc. Impulse laser system. In some cases, the light source 102 may be and/or include features of a non-collinear optical parametric amplifier CPA-Series laser manufactured by Clark-MXR, Inc. The non-collinear optical parametric amplifier may be seeded by a white light continuum, that performs non-collinear, optical parametric amplification capable of generating extremely short and intense pulses when pumped by a regenerative amplifier. The regenerative amplifier may be a CPA-Series fiber seeded Ti: Sapphire regenerative amplifier manufactured by Clark-MXR, Inc.

In some embodiments, the system 100 can further include a surface 106 formed from a material. The material of the surface 106 may be an ENZ material having characteristics as described herein. Some examples of ENZ materials of the surface 106 can include metal-ion doped metal oxides, hyperbolic materials, noble metals, and simple s-electron metals. In one example, the material of the surface 106 may be a silver material, such as Ag(111). In another example, the material of the surface 106 may be a semiconductor material, such as SnSe₂.

In some embodiments, the oscillation frequency and/or the wavelength of the light beam 104 may be selected based on a work function of the material of the surface 106 and/or a frequency dependent E response of the material of the surface 106. As an example, when the material of the surface 106 is Ag(111), the oscillation frequency of the light beam 104 may be approximately 0.937 PHz (e.g., with a period of approximately 1 fs) based on the wavelength of the light beam 104 being selected as approximately 320 nm, where Ag(111) has an ENZ condition (e.g., ϵ near zero or equal to zero) when irradiated by the light beam 104. In some cases, the light beam 104 may be continuous or pulsed. A pulsed light beam may include one or more (e.g., two) light pulses. When the light beam 104 is pulsed and includes one or more light pulses, each of the light pulses may have a duration equivalent to a period of oscillation of the light beam 104, such that each pulse includes one wavelength. In an example, the light pulses may have a duration in a range of about 1 fs to about 10 fs. Each of the light pulses can be identical in energy, polarization, and intensity. In some cases, the light beam 104 can include one or more light pulses acting individually on the surface 106.

In some cases, a carrier envelope phase (CEP) of the light beam 104 (e.g., pulsed light beam) may be controlled. For a pulsed light beam having, for example, a 0.937 PHz optical frequency (e.g., corresponding to about a 1 fs time period), the CEP may be the phase between a carrier frequency of the light beam 104 and an envelope of pulse field oscillations of the light beam 104. The pulse carrier frequency in a PHz-level frequency range can be locked to the pulse envelope function (e.g., using carrier envelope-phase locking).

A relative phase difference or time delay may exist between the light pulses. In some cases, the light pulses can overlap in time. As an example, the light source 102 may emit a single light pulse that is split into two light beams (e.g., using an interferometer 112, as described herein), which are then combined into a single light beam 104 (e.g., having waveforms shifted in phase or time). Alternatively or additionally, the light beam 104 can be formed by emitting two or more light pulses from the light source 102 at the same time. The light beam 104 can form an optical field that irradiates at least part of the surface 106. In some cases, the light beam 104 can have linear polarization, circular polarization, or elliptical polarization.

In some embodiments, the system 100 can include the light source 102 and the surface 106, as described above. In some embodiments, the system 100 can further include one or more optical devices 110 (also referred to as an optical system or “optics”) such that the light beam 104 travels through the optics 110 before reaching the surface 106. The optics 110 can generate, control, and/or influence the relative phase between the first and second light pulses of the light beam 104. Example optics 110 can include one or more phase retarders, a vortex plate, and/or spatial light modulator. For instance, the optics 110 may be passive when a phase retarder is implemented. In some cases, the optics 110 can provide feedback to the light source 102 to cause and control carrier envelope-phase locking. The optics 110 may be active when a spatial light modulator is implemented. The spatial light modulator can define how the light beam 104 irradiates the surface 106, which can be beneficial in quantum computing applications, as described below. For example, the spatial light modulator can vary the position of the light beam 104 on the surface 106. In some cases, the optics 110 can include one or more negative dispersion mirrors configured to compensate for positive dispersion in other optics 110. In some cases, the optics 110 can include a low dispersion CaF2 lens configured to focus the light beam 104 (e.g., the first and second light pulses) to a desired spot size (e.g., 30 μm in diameter) on the surface 106. The lens can function to focus the light beam 104 and/or can provide a vacuum barrier to a vacuum chamber containing the surface 106. For example, the surface 106 can be placed in a vacuum chamber and a wall of the vacuum chamber can include the lens. The lens may be coupled to a movable mount that allows a focus of the light beam 104 to be adjusted, thereby providing control over the optical field area and/or intensity applied to the surface 106. The lens can be sealed to the vacuum chamber to help maintain a vacuum barrier.

In some embodiments, the example system 100 can include an interferometer 112 positioned between the light source 102 and the surface 106. When optics 110 is part of the system 100, the interferometer 112 can be positioned between the light source 102 and the optics 110. The interferometer 112 can be used to collect information related to the light beam 104 contacting the surface 106. In some cases, the interferometer may receive a single light pulse from the light source 102 and may convert the single pulse into two separate pulses. For example, the interferometer 112 may include a beam splitter that splits the single light pulse into first and second light pulses. The interferometer 112 may recombine the first and second light pulses to form the light beam 104 containing the first and second light pulses. The two pulses in the combined light beam 104 can be identical (e.g., have a same duration, same polarity, etc.) but can be shifted in time to achieve a phase shift or time delay between the pulses. In some cases, the interferometer 112 can be used to control and/or define a relative phase (e.g., phase shift) or time delay between the pulses in the light beam 104. For example, the relative phase can be in the range of approximately −π to approximately π radians. In some cases, the interferometer 112 may be or include the microscopy instrument platform described in U.S. Pat. No. 8,085,406 issued on Dec. 27, 2011, the entire contents of which are incorporated herein by reference. In certain examples, the interferometer may be an interferometrically stabilized Mach-Zehnder interferometer (MZI). The interferometer may generate two collinear replicas of a source pulse. A source pulse (e.g., from the light source 102) may enter the MZI, where the MZI may replicate the source pulse into two identical, collinear phase-locked pulses. The two pulses can be delayed and the delay is controlled through the optical path within one of the arms of the MZI. Semi-reflective mirrors in the MZI can split the pulses into different optical paths, and subsequently make them collinear, but with a mutual delay after exiting the MZI.

In some embodiments, when the light beam 104 is pulsed, an intensity and/or a phase of an optical field corresponding to the light beam 104 may be based on a relative phase and/or a time delay between a pair of the light pulses. A relative phase between a successive pair of the light pulses included in the light beam 104 may be based on a phase difference between the pair of light pulses. A relative phase and/or a time delay between a successive pair of light pulses may be selected and controlled (e.g., via the interferometer 112) based on the wavelength and/or oscillation frequency of the light pulses. In some cases, a relative phase between a pair of the light pulses (e.g., first and second light pulses) of the light beam 104 may range from approximately −π to approximately π radians. A relative phase and time delay between a pair of the light pulses may be controlled using mechanical motion of structures (e.g., mirrors) that determine the light pathlength. The relative phase and time delay can be controlled either mechanically by moving the structures, or optically by transiently changing the index of refraction of a material that transmits the light pulses. The relative phase and time delay between a successive pair of the light pulses may be controlled based on the light pathlength and/or the index of refraction of a material that transmits the light pulses. The light source 102, the optics 110, and/or the interferometer 112 may (i) include component(s) that control a light pathlength for the light beam 104 and/or (ii) include a material that transmits the light pulses. In one example, a beam splitter in the interferometer 112 splits light into two beams, and one of the beams travels along an adjustable pathlength before the two beams are recombined to form the light beam 104.

In some embodiments, as described above, a time delay between a pair of the light pulses of the light beam 104 may be controlled to range from 0 to approximately half of the period of the light beam 104. In some cases, the time delay between a pair of the light pulses of the light beam may be a sum of (i) an integer multiple of the period of the light beam 104 and (ii) a fraction of the period of the light beam 104. For a pulsed light beam and when the time delay between a pair of light pulses is 0 (e.g., such that there is no phase-shift between the pair of light pulses), the optical fields of the individual light pulses can interfere constructively and the combined optical field can have generated electromagnetic field waves having a maximum amplitude. For a pulsed light beam and when the time delay between successive light pulses is half of the period of the light beam (e.g., corresponding to a relative phase of approximately −π approximately π radians), the optical fields of the pulses can interfere destructively and the combined optical field can have generated electromagnetic field waves having a minimum amplitude.

In some embodiments, as described herein the light beam 104 may irradiate the surface 106. As an example, where the light beam 104 may irradiate anywhere on the surface of the ENZ material (e.g., based on the light beam 104 overlapping with the surface 106 in space and time). An area on the surface 106 that is irradiated by the light beam may be based on the light source 102, the optics 110, and the interferometer 112. In some cases, the light beam 104 may irradiate, for example, a 30 μm diameter area on the surface 106. In some cases, the diameter of the light beam 104 can control the strength of the optical field of the light beam 104 and an intensity of the light beam 104. A diameter of the light beam 104 can control an electronic response (e.g., emission of photoelectrons), thereby enabling a desired electronic response based on the diameter of the light beam 104. In some cases, at least part of the optical field corresponding to the light beam 104 may be normal to the surface 106. In some cases, the light beam 104 may (i) preferably irradiate the surface 106 at an angle of incidence to the surface 106 in a range of approximately 50° to 70° (e.g., from a line normal to the surface 106) and (ii) cause generation of an electromagnetic field (e.g., electric field) that is polarized in a plane of the light reflected from the surface 106. The angle of incidence of the light beam 104 can define the applied optical field intensity and/or generated electromagnetic field (e.g., electric field) strength. Use of a light beam 104 that forms an optical field directed to the surface 106 (e.g., surface formed from an ENZ material such as metals or doped semiconductors) may drive and control electron emission from the surface 106 into a dielectric with sub-femtosecond (e.g., attosecond) time resolution. Based on a material work function being modulated at ENZ by an optical field having an oscillation frequency in a range of approximately 0.8-1.2 PHz, the nonlinearity of electron field emission at ENZ may be a limit at which devices can transmit optoelectronic signals. In some cases, the CEP of the light beam 104 may define a sign and/or an instantaneous strength of the electric field generated at the surface of the ENZ material by the optical field. When the CEP of the light beam 104 is not controlled, the sign of the electric field may vary between positive negative from light pulse to light pulse.

Referring to FIG. 2, in step 202 of method 200, the light source 102 and/or other components of the system 100 can generate a light beam 104. The light beam 104 can form an optical field having an intensity and a phase. The light beam 104 can include at least a first light pulse and a second light pulse, where a relative phase and time delay between the first and second light pulses are controlled by the interferometer 112. In some cases, when the light beam 104 is pulsed, the light beam 104 can include any number of light pulses. Each light pulse may have a respective intensity and phase. Each of the first and second light pulses can have a duration that is selected based on a period of oscillation of the light beam 104, such that each pulse includes one wavelength, multiple wavelengths, or portions thereof. In an example, the first and second light pulses may each have a duration equivalent to a period of oscillation of the light beam 104. In another example, the first and second light pulses may each have a duration equivalent to a fraction of a period of oscillation of the light beam 104. When the first and second light pulses each have a duration equivalent to a fraction of a period of oscillation of the light beam 104, the frequency and phase of the resulting optical field may not be precisely defined, but may be more precisely defined for a particular frequency component of the optical field. In some cases, each of the light pulses may have the same duration. The intensity and the phase of the optical field may be based on a time delay and/or a relative phase difference between the first light pulse and the second light pulse. For example, when the first and second light pulses overlap in time and space on the surface 106, constructive or destructive interference of the first and second light pulses can define the intensity and the phase of the optical field. The relative phase may be in the range of approximately −π to approximately π radians and/or the time delay may have a duration in a range of approximately 0 to half of a period of the light beam 104 including the first light pulse and the second light pulse.

In some embodiments, when exposed to the light beam 104 and the corresponding optical field, in step 204 of method 200, the surface 106 is configured to enable excitation of electromagnetic (e.g., electric) field waves at a material-dielectric interface of the surface 106. The strength and/or intensity of the electromagnetic field waves may be based on the strength and/or intensity of the optical field corresponding to the light beam 104. In some embodiments, when exposed to the light beam 104, in step 204 of method 200, the surface 106 is configured to cause emission, based on the electromagnetic field waves and by multi-photon photoemission (mPP) and/or field emission, of photoelectrons from the surface 106 at a material-dielectric interface of the surface 106. The surface 106 may be formed from a material, where at least of a portion of the material has e of approximately 0 (e.g., when exposed to the light beam 104). The emission of the photoelectrons (e.g., the number of photoelectrons emitted or a rate at which photoelectrons are emitted) may be based on (e.g., a function of) the intensity and/or the phase (e.g., relative phase between successive pulses of the light beam 104) of the optical field corresponding to the light beam 104.

In some cases, the electromagnetic field waves may cause emission of at least some of the photoelectrons by field emission. The emission of the photoelectrons (e.g., the number of photoelectrons emitted or a rate at which photoelectrons are emitted) may be based on the strength (e.g., intensity) of the electromagnetic field waves. The electromagnetic field waves may cause field emission by modulating (e.g., suppressing and/or reducing) the vacuum potential that defines the work function potential of the material of the surface 106.

In some cases, emission of the photoelectrons from the surface 106 by field emission may be based on an amplitude of the light beam 104. For example, a number and/or a rate of photoelectrons emitted from the surface 106 by field emission may be dependent on an amplitude of the light beam 104. In some cases, emission of the photoelectrons from the surface 106 by mPP (e.g., 2PP) may be based on an intensity (e.g., square of the amplitude) of the light beam 104. For example, a number and/or a rate of photoelectrons emitted from the surface 106 may be dependent on an intensity (e.g., square of the amplitude) of the light beam 104.

In some cases, the photoelectrons may be emitted from the material of the surface 106 at a frequency that is based on the material of the surface 106. The material of the surface 106 may be a metal single crystal material (e.g., Ag(111)) or a semiconductor material (e.g., a SnSe₂ material or other 2D or 3D semiconductors). As described herein, the material of the surface 106 may be an ENZ material such that e of the material can change between negative and positive (e.g., pass through ϵ=0). The wavelength and/or the oscillation frequency of the light beam 104 may be selected based on a work function of the material and/or a frequency dependent ϵ response of the material. As an example, the wavelength may be approximately 320 nm and/or the oscillation frequency may be approximately 0.937 PHz. The material-dielectric interface may be an interface between the surface 106 and the dielectric (e.g., vacuum, air, etc.) adjacent to the surface 106. In some cases, the oscillation frequency of the light beam 104 can influence whether the photoelectrons are emitted via a quantum response (e.g., mPP) and/or a classical field response (e.g., field emission). In some cases, when the light beam 104 includes one or more light pulses acting on the surface 106, emission of the photoelectrons can be defined by the strength and pulse envelope duration of the light beam 104.

In some embodiments, the photoelectrons emitted from the surface 106 may be detected using one or more techniques. In some cases, the photoelectrons may be detected using a detection system including a collector and an imaging system. The collector can include one or more electromagnetic lenses configured to direct the photoelectrons onto the imaging device. Directing the photoemitted electrons may include reflecting and/or refracting the photoelectrons.

In some embodiments, the emitted photoelectrons can be imaged by interferometric time resolved photoemission electron microscopy (ITR-PEEM).

In some embodiments, the emitted photoelectrons can be detected using a spectroscopic technique, such as a photoelectron spectroscopic technique, a multiphoton spectroscopic technique, or a multiphoton ionization photoelectron spectroscopic technique.

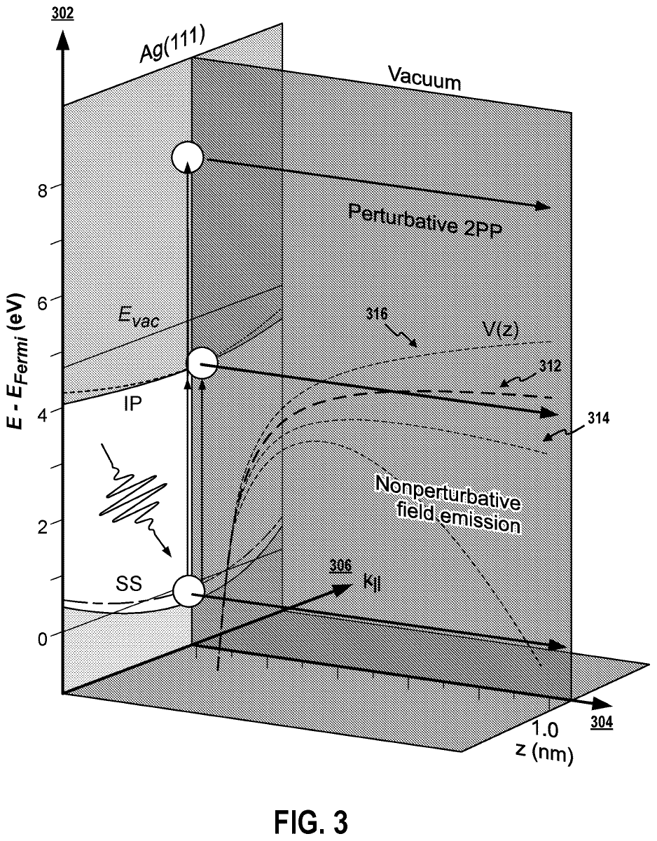

In some embodiments, the above described system 100 and method 200 may be applied for use with a surface 106 formed from single crystal metal Ag(111). In some cases, interaction between the light beam 104 and the surface 106 can cause both low-field quantum electron emission and high-field classical electron field emission from the surface 106. In the material of the surface 106, the optical field of the light beam 104 may be configured to cause transfer of electrons of the material of the surface 106 from the Fermi level (E_{F}) into a vacuum level (E_{vac}), thereby causing emission of the electrons from the surface 106. To cause the transfer, the optical field of the light beam 104 may cause promotion of the electrons to above a work function (Φ) of the material. Based on a type of the material, the work function (Φ) may be in the range of approximately 2-6 eV. The vacuum level for the material may be defined as E_{vac}=E_{F}+Φ. In Einsteinian photoemission, the material follows single photon absorption when the photon energy (ℏω) of photons of the optical field is greater than the work function of the material (e.g., ℏω>Φ), such that the photon energy is proportional to I. With respect to high field interactions for when the photon energy (ℏω) of photons of the optical field is less than the work function of the material ℏω<Φ, electron emission from the surface 106 can occur by multiphoton absorption as a perturbative quantum mechanical response. The optical field of the light beam 104 can generate a ladder of Floquet quasi-energy states, each separated by the photon quantum energy (ℏω), such that absorption of m quanta (e.g., where mℏω>Φ), causes mPP from the surface 106. Such a response is 2m order of the applied electric field (e.g., such that \vec{E}^{2m}). Based on a high nonlinearity of the response, nonperturbative, field-induced effects defined by \vec{E}¹ may contribute to emitted photoelectron spectra. High electric fields formed in response to the light beam 104 can induce splitting and distortion of electronic bands of the material of the surface 106 as the Rabi frequency of the optical interaction exceeds the electronic polarization dephasing rates. High electric fields can therefore change the topology of electronic bands of the material of the surface 106 through which electrons evolve. In some cases, high electric fields can reduce E_{vac} by the pondermotive energy, or time dependently modulate the electron binding image potential d\vec{V}(dt)=\vec{V}_{IP}−\vec{E}(t)·dz, where z is the interaction distance, to induce an optical field electron emission. The applied optical field of the light beam 104 can have a dual effect on the surface 106 depending on a phase of the applied optical field, including: (i) modulating the image potential and therefore, depending on the sign, raising or lowering the binding energies of the image potential (IP) states of the material with respect to E_{vac}, and (ii) accelerating electrons towards the surface 106 or into the dielectric (e.g., vacuum as illustrated in FIG. 3).

Referring to FIG. 3, a schematic diagram of competing perturbative two photon photoemission (2PP) and nonperturbative field emission from a surface (e.g., surface 106) in response to a light beam (e.g., light beam 104) is illustrated. The light beam may be pulsed and have characteristics of the light beam 104 as described herein. The surface may be formed from a single crystal Ag(111) material. The axis 302 illustrates the band structure of the material of the structure involving the partially occupied SS state and unoccupied IP state. The axis 304 illustrates the simulated surface image potential line 312) and its changed lines 314 and 316 caused by applying an optically-generated electric field of ±1 volt (V) per nm, or more, respectively. The response of the Ag(111) material at ENZ can amplify the optical field acting on electrons in the material. The field induced at the material-dielectric interface can be sufficiently strong to emit electrons from below the Fermi level, without necessity to excite the electrons to the image potential state. The axis 306 illustrates the electron parallel momentum (k_{∥}).

In some embodiments, for the example of a metal (e.g., single crystal Ag(111)) as the material of the surface 106, the response of the surface 106 to an applied optical field corresponding to the light beam 104 when the surface 106 has an ENZ condition may be investigated. As described herein, e of a material of the surface 106 varies with a frequency of oscillation of an optical field applied to the material (e.g., as represented by ϵ(ω)). For every metal, ϵ may pass through zero (e.g., from Re(ϵ)<0 to Re(ϵ)>0) below the onset of interband optical transitions. The Re(ϵ)=0 condition may define the bulk plasma frequency (ωₚ) of a material (e.g., metal) where electrons cease to screen incoming optical fields, thereby allowing the optical fields to penetrate into the metal as electron charge density waves with zero group velocity and infinite phase velocity. At an ENZ condition where ϵ of a material passes through ϵ=0 in response to an optical field of light beam 104, (i) the optical fields may enhance electric fields at the surface 106, (ii) the linear optical response (e.g., reflectivity) is suppressed, and (iii) the light-material interaction can become nonlinear, and therefore, can be driven to be nonperturbative.

In some embodiments, for the example of a metal such as single crystal Ag(111) as the material of the surface 106, a transition to a nonperturbative response may be examined in response to the light beam 104 irradiating the surface 106. For a surface 106 of single crystal Ag(111), the ωₚ of approximately 3.8-3.9 eV is below the material's work function (Φ) of 4.55 eV. In some cases, low-field excitation of the surface 106 at ℏωₚ=3.85 eV dominantly excites electrons from the materials Shockley surface (SS) state via near-resonant transition to its unoccupied IP state at a binding energy defined by E_{b}=E_{vac}−0.7 eV. For the surface 106, the transition from 2PP at low fields to field emission at high fields may be examined by a time-resolved photoelectron spectroscopy. An interferometric time-resolved experiment may be performed using the system 100, where identical pump and probe light pulses derived from a light beam 104 generated by the light source 102, are generated within an interferometer 112 (e.g., a Mach-Zehnder interferometer) with a relative time delay (τ) between the pulses controlled with less than approximately 50 attosecond (e.g., 34 attosecond) (10⁻¹⁸ s) precision to produce the total electric field defined by \vec{E}ₜₒₜ=\vec{E}ₚᵤₘₚ(t)+\vec{E}_{probe}(t+τ), where t refers to a point in time for a time-varying electric field (\vec{E}ₜₒₜ). For excitation of electrons in the material at 3.8 eV, varying the relative phase between the light pulses by approximately −π to approximately π radians (e.g., where τ ranges from about −0.55 fs to about 0.55 fs) can (i) modulate \vec{E}ₜₒₜ from the maximum electric field to a minimum field and (ii) modulate the quantum mechanical phase of the interaction between the light pulses of the light beam 104 and the surface 106.

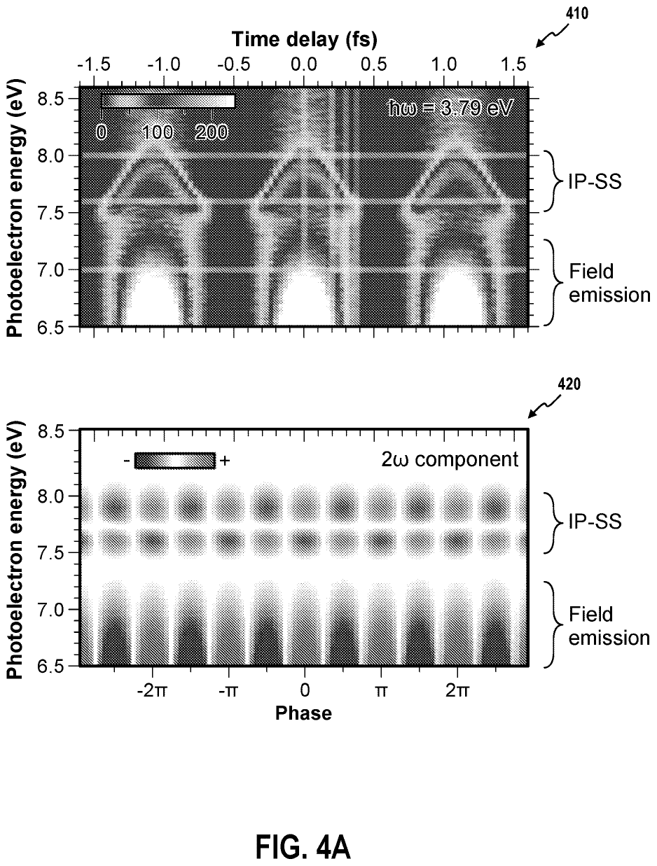

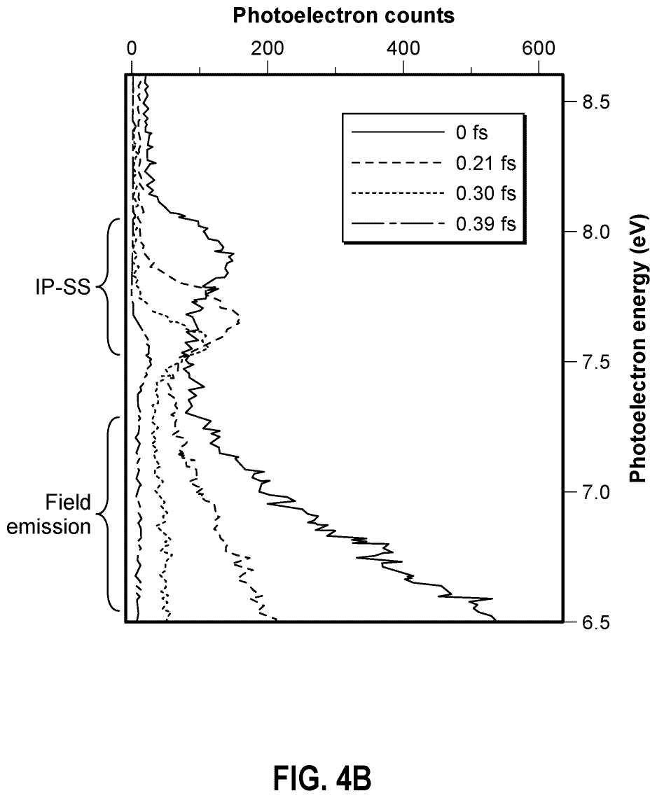

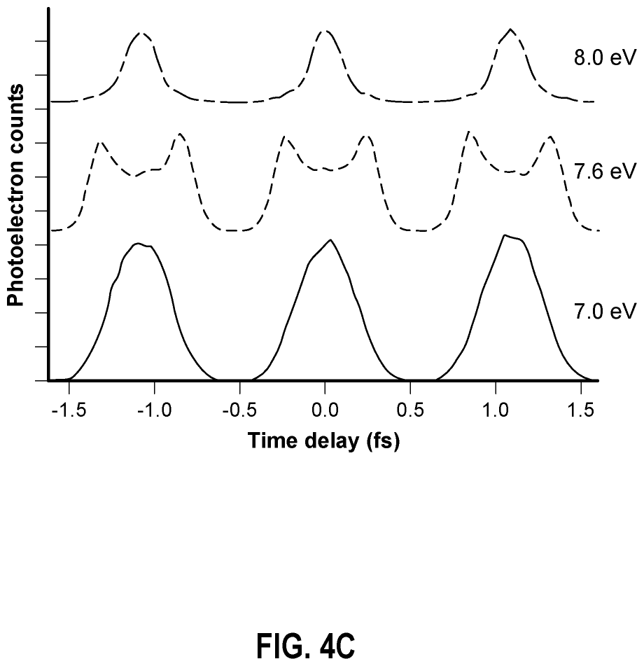

Referring to FIGS. 4A-4C, a coherent response of a material (e.g., Ag(111)) of a surface (e.g., surface 106) in response to a light beam (e.g., light beam 104) is illustrated. The coherent response can be measured by recording the photoelectron energy (E_{final}) vs. parallel momentum (k_{∥}), and time delay between successive light pulses of the light beam 104 (τ). FIG. 4A illustrates a segment of E_{final} vs. τ for the k_{∥}=0 Å⁻¹ interferometric two-pulse correlation chronograms for excitation at ℏω=3.79 eV, near Re(ϵ)~0, and a pump-probe light pulse relative phase range of −3π<τ=0 fs<+3π (e.g., a time delay range of approximately 3.2 fs). The data show the response of Bloch electrons to modulation of \vec{E}ₜₒₜ when the light beam has a PHz level oscillation frequency. In the diagram 410 of FIG. 4A, a 2D interferogram of the detected number of photoelectrons (e.g., indicated by the scale ranging from 0 electrons to 250 electrons) vs. photoelectron energy (E_{final}) and time delay τ=±1.6 fs, measured with ℏω=3.79 eV at a surface 106 of Ag(111) is illustrated. In the diagram 420 of FIG. 4A, a 2D interferogram of the detected number of photoelectrons (e.g., indicated by the scale ranging from − to +) vs. photoelectron energy (E_{final}) and a phase of approximately −3π to approximately 3π radians, measured with ℏω=3.79 eV at a surface 106 of Ag(111) is illustrated. While FIGS. 4A-4C illustrate particular numbers of detected electrons, an actual number of electrons emitted by the surface (e.g., surface 106) can be greater than the numbers of detected electrons.

To analyze the competition between the 2PP and field emission from the surface (e.g., surface 106), the interference structure near τ~0 fs may be examined. As illustrated in the diagram 410 of FIG. 4A, the periodic signals in the chronograms appear as an arrow barb and a shaft that reach the maximum energy and intensity for τ=0 fs, and the same structure is reproduced for an added time delay of τ from about −n2π to about n2π, where n is an integer. To reveal how different signal components respond to varying \vec{E}ₜₒₜ, the signal may be dissected by taking vertical and horizontal line profiles with respect to E_{final} and τ, as well as by examining the phase of E_{final} at twice the driving frequency ℏω as illustrated in the diagram 420. FIGS. 4B and 4C illustrate the vertical and horizontal line profiles, respectively, with respect to E_{final} and τ. FIG. 4A further illustrates the phase of E_{final} at twice the driving frequency ℏω. At the lowest \vec{E}ₜₒₜ (e.g., corresponding to τ=±0.4 fs), the barbs that dominate consist of 2PP signal involving near-resonant IP←SS excitation that appears as a spectral peak. The phase of the 2ω polarization shows that this peak structure is modulated by ±0.2 eV depending on the sign of the applied field, which varies at 2ω. The driving field creates a coherent polarization that persists longer than the period of ω, and therefore the barb structure shows the adiabatic following of the IP←SS polarization of the \vec{E}ₜₒₜ image potential modulation. The perturbative response reaches its relative maximum strength for τ=±π/2 (e.g., about 0.24 fs), but for smaller delays \vec{E}ₜₒₜ increases and the shaft signal, corresponding to field emission, starts to dominate. Besides modulating the IP state energy, \vec{E}ₜₒₜ also modulates the vacuum potential of Ag(111) (or another material (e.g., ENZ material) as described herein), thereby opening the field emission channel for positive applied electric fields that accelerate electrons from the surface. The barb structure peak reaching the largest E_{final} energy when the field emission is the highest may not be attributed to the modulation of its binding energy with respect to E_{vac} because they occur in the opposite direction. The energy of the barb structure peak may be a consequence of the field suppression and electron acceleration during the field emission cycle. While the coherent polarization persists over multiple cycles, the photoelectron acceleration may follow the applied surface field as it evolves on the screening sub-femtosecond time scale.

Table 1 includes low, high, and typical values for various parameters associated with the systems (e.g., system 100) and methods (e.g., method 200) described herein. Each listed value can be a minimum, maximum, or average value. Various embodiments include any parameter value (e.g., integer or decimal value) within the cited ranges. For example, the light beam pulse duration can be greater than, less than, and/or equal to 0.01, 0.02, . . . , 0.09, 0.1, 0.2, . . . 0.9, 1, 2, 3, . . . , 9, 10, 11, . . . , 99, 100, 101, . . . , 999, or 1000 fs. Express support and written description of these values for each parameter are hereby represented.

| Parameter | Low | Typical | High |
|---|---|---|---|
| Light Beam Pulse Duration (fs) | 0.01 | 1 to 10 | 1000 |
| Time Delay for Light Beam Pulses | 0 | 0 to 550 | 10000000 |
| (attoseconds) | | | |
| Relative Phase for Light Beam Pulses (radians) | −π | $- \frac{π}{2} to \frac{π}{2}$ | π |
| Light Oscillation Frequency (PHz) | 0.001 | 0.8 to 1.2 | 10 |
| Light Beam Wavelength (nm) | 30 | 250-333 | 300,000 |
| Light Beam Angle (degrees) | 0< | 50 to 70 | <90 |

### Table 1. Exemplary Parameters

In some embodiments, a PHz electronic device may incorporate the systems and methods described herein and may be about 1000000 times faster than conventional electronic devices. A PHz electronic device may incorporate attosecond fast electron emission currents for optical-field sampling applications. A PHz electronic device may incorporate control of emission of photoelectrons at sub-femtosecond resolutions by use of optical fields having PHz scale oscillation frequencies. Applications of the systems and methods described herein can include quantum computing applications, signal processing applications (e.g., multi-input parallel signal processing), and/or nanophotonic applications. The systems and methods can be used in applications that are referred to as light wave electronics, where optical fields induce currents on the optical field period time scale. Further examples of nanophotonic applications can include light field induced electron currents for spectroscopy, electron accelerator, and/or real and reciprocal space microscopy applications.

In some embodiments, for a quantum computing application, the emitted photoelectrons from the system 100 may interact with other electrons coherently on a time scale that is faster than decoherent interaction.

In some embodiments, the systems and methods described herein can be used to measure, assess, and/or determine properties of materials, such as composition and/or structure (e.g., a crystalline structure). In a spectroscopy application, for example, the emitted photoelectrons can be used to probe electron energy and electron momentum distributions. Alternatively or additionally, the emitted photoelectrons may be used to determine electron correlation and/or superconducting properties of materials. The emitted photoelectrons may be used to structurally probe materials.

In certain implementations, the systems and methods described herein can be incorporated into an electron diffraction device, which can be used to identify a chemical composition or a component of a material and/or to locate a position of atoms in the material (e.g., a crystalline structure). Alternatively or additionally, the emitted photoelectrons can be used to probe time-varying phenomena of materials (e.g., during phase changes, melting, solidification, or chemical reactions) on short time scales (e.g., on the order of picoseconds) via diffractive scattering. For example, a diffraction pattern may be used to observe chemical and/or physical processes for a material at sub-femtosecond time-scales, such as laser-induced melting, structural changes, and/or chemical reactions. Electron probing may occur on a picosecond timescale during electron microscopy and/or electron diffraction measurements. Such techniques can be used for a variety of materials, including, for example, metals and/or semiconductors.

In some embodiments, for a microscopy application, the emitted photoelectrons may be used to image the motion of surface plasmon polaritons (SPPs).

In some embodiments, the emitted electrons can be incorporated in electron accelerators as energetic probes of the structure of matter down to a sub-atomic scale or as free electron sources of ultrafast optical pulses.

In some embodiments, an electrical circuit may be integrated with the system 100, where the circuit includes at least part of the surface 106. The emitted photoelectrons may be used to probe the circuit. Alternatively or additionally, the systems and methods described herein can be used to drive electrical currents in the circuit.

### Terminology

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A system for emitting photoelectrons, the system comprising:
a light source configured to generate a light beam comprising a first pulse and a second pulse separated by a time delay; and
a material defining a surface configured to be exposed to the light beam, the material having a dielectric permittivity of approximately 0 when exposed to the light beam, wherein the light beam causes:
formation of electromagnetic field waves at a material-dielectric interface associated with the surface, and
emission of photoelectrons from the material at the material-dielectric interface, wherein the emission is a function of the time delay and an intensity of the light beam.

2. The system of claim 1, wherein the light beam comprises an oscillation frequency from about 0.8 petahertz (PHz) to about 1.2 PHz.

3. The system of claim 1, wherein the light beam comprises a wavelength of about 320 nanometers.

4. The system of claim 1, wherein a wavelength of the light beam is selected based on a work function of the material and/or a frequency dependent dielectric permittivity response of the material.

5. The system of claim 1, further comprising an interferometer configured to receive light from the light source and generate the first pulse and the second pulse using a beam splitter.

6. The system of claim 1, wherein the time delay defines a phase shift between a waveform in the first pulse and a waveform in the second pulse.

7. The system of claim 1, wherein the time delay is from about 1 attosecond to about 600 attoseconds.

8. The system of claim 1, wherein the light beam is directed to the surface at an angle from about 50° to about 70° relative to a normal direction of the surface.

9. The system of claim 1, wherein the light beam is configured to modulate a work function of the material to cause emission of the photoelectrons.

10. The system of claim 1, wherein the light beam is configured to cause transfer of the photoelectrons of the material from a Fermi energy level into a vacuum energy level.

11. The system of claim 1, wherein the dielectric permittivity of the material is a function of an oscillation frequency of the light beam.

12. The system of claim 1, wherein the material comprises a metallic single crystal material or a semiconductor material.

13. The system of claim 12, wherein the metallic single crystal material is a silver material, and wherein the semiconductor material is a SnSe₂ material.

14. The system of claim 1, wherein the material comprises an epsilon near zero (ENZ) material.

15. The system of claim 1, wherein the emission of the photoelectrons is by multi-photon photoemission and/or field emission.

16. The system of claim 1, wherein the material-dielectric interface comprises a material-vacuum interface or a material-semiconducting material interface.

17. The system of claim 1, wherein the system is configured of use in a nanophotonic system.

18. The system of claim 1, wherein a response of the photoelectrons is configured to carry and/or process information for quantum computing.

19. The system of claim 1, wherein a response of the photoelectrons is configured for a signal processing application.

20. The system of claim 1, wherein the surface forms part of an electrical circuit.

21. The system of claim 1, wherein the system is included in at least one of a spectroscopy device, a microscopy device, or an electron diffraction device.

22. A method for emitting photoelectrons, the method comprising:
generating a light beam comprising a first pulse and a second pulse separated by a time delay; and
exposing a material defining a surface to the light beam, wherein (i) the material has a dielectric permittivity of approximately 0 when exposed to the light beam, and (ii) the light beam causes:
(a) formation of electromagnetic field waves at a material-dielectric interface associated with the surface, and
(b) emission of photoelectrons from the material at the material-dielectric interface, wherein the emission is a function of the time delay and an intensity of the light beam.
